(19) United States
(12) Patent Application Publication
(10) Pub. No.: US 2008/0171127 A1
(43) Pub. Date: Jul. 17, 2008

(54) Processed Potato and Process for Producing the Same

(75) Inventors: Yoshikazu Isono, Tokyo (JP); Aya Nakai, Tokyo (JP); Hideaki Kobayashi, Tokyo (JP); Masahiro Ariizumi, Tokyo (JP); Kentaro Kobayashi, Tokyo (JP)

Correspondence Address: ROETZEL AND ANDRESS, 222 SOUTH MAIN STREET, AKRON, OH, 44308, US

(73) Assignee: Q.P. CORPORATION, Tokyo, JP (JP)

(21) Appl. No.: 11/720,456

(22) PCT Filed: Nov. 29, 2005
(86) PCT No.: PCT/JP05/21900

§ 371 Date: Mar. 17, 2008

(30) Foreign Application Priority Data
Nov. 30, 2004 (JP) JP2004-345535

(51) Int. Cl. A23L 1/216; A23L 1/00

(52) U.S. Cl. 426/637; 426/520; 426/506

(57) ABSTRACT

A process for producing a potato product includes hermetically enclosing potatoes in a container having an average oxygen permeability of 5 cc/m²·day·atm or less, and heating the potatoes at 60 to 95° C., the potatoes being heated under conditions where dissolved oxygen content in the container becomes 5% O₂ or less at least when heating is completed.

### TECHNICAL FIELD

The present invention relates to a potato product with a particularly improved flavor and a process for producing the same.

### BACKGROUND ART

It is widely known that the flavor of food deteriorates due to oxidation caused by oxygen in air. Therefore, when distributing and storing food, the food is generally enclosed in a metal can or a glass bottle which does not allow oxygen to permeate, a resin container having a low oxygen permeability, and the like. Technologies have been known which reduce the dissolved oxygen content in the raw material or prevent oxygen from being mixed when producing food. For example, JP-A-6-141776 discloses a technology of obtaining a high-quality coffee beverage by extracting coffee in a state in which oxygen does not substantially exist, and JP-A-10-295341 discloses a technology of obtaining a product with excellent flavor by heating a milk beverage or a fruit drink in a state in which the dissolved oxygen content is reduced to 5 ppm or less.

On the other hand, a technology of positively reducing the dissolved oxygen content in a product has not yet been proposed for a potato product which is obtained by heating potatoes or a semifinished product containing potatoes, which can be stored for about several tens of days, for example. As the method of processing a potato product, JP-A-8-242825 discloses a retort processing method for meat and potato stew. In this processing method, the raw materials for meat and potato stew are boiled and enclosed in a gas-barrier heat-resistant bag or container. After replacing the atmosphere inside the bag or container with nitrogen gas, the raw materials are boiled for cooking and subjected to retort sterilization under conditions of 120° C. or more for four minutes or more. According to this technology, since the atmosphere inside the container filled with the raw materials is replaced with nitrogen gas, it is considered that the effects of oxygen are considerably reduced.

### DISCLOSURE OF THE INVENTION

However, the studies conducted by the inventors of the invention have revealed that the flavor of a potato product deteriorates when heating potatoes at a high temperature of 120° C. or more, as employed in the technology disclosed in JP-A-8-242825.

In view of the above situation, an object of the invention is to provide a container-packed potato product which has a significantly excellent flavor and can be stored for a long time, and a process for producing the same.

A first process for producing a potato product according to the invention comprises:

hermetically enclosing potatoes in a container having an average oxygen permeability of 5 cc/m²·day·atm or less; and

heating the potatoes at 60 to 95° C., the potatoes being heated under conditions where dissolved oxygen content in the container becomes 5% O₂ or less at least when heating is completed.

The first process for producing a potato product according to the invention may have the following features.

The potatoes may be heated in deoxygenated water with a dissolved oxygen content of 6% O₂ or less.

The process may further comprise heating the potatoes before hermetically enclosing the potatoes.

A second process for producing a potato product according to the invention comprises:

hermetically enclosing a semifinished product containing potatoes in a container having an average oxygen permeability of 5 cc/m²·day·atm or less; and

heating the semifinished product at 60 to 95° C., the semifinished product being heated under conditions where dissolved oxygen content in the container becomes 5% O₂ or less at least when heating is completed.

The second process for producing a potato product according to the invention may have the following features.

The semifinished product may be heated in deoxygenated water with a dissolved oxygen content of 6% O₂ or less.

At least the potatoes contained in the semifinished product may have been heated.

At least some of materials contained in the semifinished product may have been deoxygenated. The deoxygenated material may be at least one of an oil-in-water emulsified food and freshwater.

A potato product according to the invention may be obtained by the process according to the invention and may have a dissolved oxygen content of 5% O₂ or less after being stored at 10° C. or less for 30 days after production.

A potato product according to the invention may have, when analyzing volatile components of the potato product by solid-phase microextraction-gas chromatography-mass spectrometry in which the volatile components are extracted at 80° C. for 30 minutes, a ratio (flavor component/oxidative degradation odor component) of a peak area (quantitative ion: m/z 104) of methional (flavor component) to the sum of peak areas (quantitative ion: m/z 81) of 2,4-nonadienal and 2,4-decadienal (oxidative degradation odor components) of 3.8 or more.

A potato product according to the invention may have, when analyzing volatile components of the potato product by solid-phase microextraction-gas chromatography-mass spectrometry in which the volatile components are extracted for 10 minutes after preheating the potato product at 95° C. for 20 minutes, a ratio (flavor component/oxidative degradation odor component) of a peak area (quantitative ion: m/z 104) of methional (flavor component) to the sum of peak areas (quantitative ion: m/z 81) of 2,4-nonadienal and 2,4-decadienal (oxidative degradation odor components) of 5.3 or more.

Since the process for producing a potato product according to the invention enables the excellent flavor of the potatoes to be produced, a potato product can be produced which is delicious in comparison with a general steamed potato product (e.g. homemade potato dish) and can be stored for a long time.

The potato product according to the invention can maintain an excellent flavor produced immediately after production for a long time.

### BEST MODE FOR CARRYING OUT THE INVENTION

The invention is described below in detail.

### 1. First Embodiment

This embodiment relates to a potato product obtained by directly heating potatoes.

A process for producing a potato product according to this embodiment includes hermetically enclosing potatoes in a container, and heating the potatoes at 60 to 95° C. In this embodiment, the potatoes are heated under conditions where the dissolved oxygen content in the container becomes 5% O₂ or less at least when heating is completed.

In this embodiment, a container having an average oxygen permeability of 5 cc/m²·day·atm or less may be used as the container. In this embodiment, the potatoes may be heated in deoxygenated water with a dissolved oxygen content of 6% O₂ or less. The above embodiments relating to the container and the heating step may be employed in combination.

Each step is described below in detail.

In a step (a) of hermetically enclosing the potatoes in the container (hereinafter called “enclosing step (a)”), the potatoes are prepared and enclosed in a bag-shaped container, and the container is sealed while removing air from the container using a vacuum sealing method or the like.

In the preparation of the potatoes, the skin and sprouts are removed from the potatoes, and the potatoes are cut into an appropriate size. The potatoes may be optionally immersed in a treatment liquid in order to prevent discoloration and breakage of the potatoes. As the treatment liquid, an aqueous solution in which sodium ascorbate, lactic acid, sodium chloride, or the like is dissolved may be used.

It is preferable that the container used in the enclosing step (a) be a bag-shaped container formed of a resin film having a low oxygen permeability. The container preferably has an average value of oxygen permeability (hereinafter called “average oxygen permeability”) over the entire container wall of 5 cc/m²·day·atm or less at a temperature of 30° C. and a relative humidity of 80%. As examples of the resin film which may be used to form such a container, a polyethylene terephthalate (PET) film, a film prepared by stacking an ethylene vinyl alcohol resin on polyethylene or the like, a film prepared by stacking polyamide or an aluminum thin film on polyethylene or the like, a stacked film having a deposited layer of a ceramic, aluminum oxide, or the like, and a stacked film coated with a polyacrylic acid resin can be given.

The average oxygen permeability of the container may be measured according to the following procedures (1) to (5).

(1) A small amount of freshwater is injected into the measurement target container. After replacing the atmosphere inside the container with nitrogen, the container is sealed under normal pressure. This causes the relative humidity inside the container to be 100%.
(2) A small amount of gas is collected from the container prepared in (1) using an injection syringe, and the oxygen concentration C₀ of the gas is measured using an oxygen sensor (e.g. trace oxygen analyzer “RO-102-SP” manufactured by Iijima Electronics Corporation).
(3) The container prepared in (1) is placed in a thermohygrostat adjusted to a temperature of 30° C. and a relative humidity of 80%, and stored for 20 days. The inside of the thermohygrostat is set at atmospheric pressure and is filled with air.
(4) A small amount of gas is collected from the container after being stored for 20 days in (3) using an injection syringe, and the oxygen concentration C₁ of the gas is measured in the same manner as in (2).
(5) The average oxygen permeability Q (cc/m²·day·atm) is calculated according to the following expression from the initial oxygen concentration C₀ (% O₂) obtained in (2), the oxygen concentration C₁ (% O₂) after storage obtained in (4), the volume V (cc) of the container, the surface area A (m²) of the inner surface of the container, the storage period T (day) (20 days), and the oxygen partial pressure P under atmospheric pressure (0.209 atm).

$$Q = \frac{( {C}_{1} - {C}_{0} ) / 100 \times V}{A \times T \times P}$$

The excellent flavor of the potatoes produced in a heating step (b) described later is stably maintained for a long time by using a container formed of a material having such a low oxygen permeability. In particular, the excellent flavor obtained immediately after production can be maintained for a long time of 30 days or more by using a container having an average oxygen permeability of 5 cc/m²·day·atm or less, as is clear from the examples described later.

The process for producing a potato product according to this embodiment may further include heating the potatoes before the enclosing step (a). This heating step may be carried out after immersing the potatoes in the treatment liquid in order to prevent discoloration and breakage of the potatoes. In this heating step, the potatoes may be blanched or boiled. This has an advantage in that the flavor of the potatoes is improved by blanching or the potatoes can be sterilized by boiling.

In the step (b) of heating the potatoes hermetically enclosed in the container (hereinafter called “heating step (b)”), the potatoes enclosed in the container are heated in freshwater at 60 to 95° C., preferably 65 to 95° C., and more preferably 85 to 95° C. If the temperature of the heating step (b) is less than 60° C., the storage properties of the potato product deteriorate due to insufficient thermal sterilization. Moreover, the excellent flavor of the potatoes may not be produced. If the temperature of the heating step (b) exceeds 95° C. as employed in retort sterilization (usually 100° C.), it is also difficult to produce the excellent flavor of the potatoes. The heating time in the heating step (b) is not particularly limited. The heating time may be determined so that the potatoes are sufficiently cooked (e.g. 20 to 60 minutes). It is preferable to cool the container-packed potato product after the heating step (b) from the viewpoint of improving the flavor of the potato product.

The heating step (b) is carried out under conditions where the dissolved oxygen content in the container becomes 5% O₂ or less, and preferably 3% O₂ or less at least when heating is completed. The term “dissolved oxygen content” used herein means the oxygen content measured using a fluorescent oxygen sensor. The dissolved oxygen content at the contact interface between the potato product and the container can be conveniently measured using the fluorescent oxygen sensor in a state in which the container is filled with the potato product. An “OxySense 101” manufactured by OxySense, Inc. (USA) may be used as the oxygen sensor. The dissolved oxygen content measurement procedure is as follows.

(1) An oxygen detection fluorescent dye film (OxyDot) is attached to the inner wall surface of a transparent or translucent container using a special silicone adhesive.
(2) The container to which the oxygen detection fluorescent dye film is attached is filled with a sample (potato product or semifinished product), and sealed after removing gasses (vacuum sealing). Since the surface of the oxygen detection fluorescent dye film which is not attached to the container adheres to the sample by vacuum sealing, the dissolved oxygen content at the contact interface between the sample and the container can be measured.
(3) Light is externally applied to the oxygen detection fluorescent dye film adhering to the sample in the container through the container wall, and fluorescence emitted from the film is detected by the sensor provided outside the container through the container wall to measure the dissolved oxygen content.
(4) Since the oxygen detection fluorescent dye film exhibits heat resistance, the dissolved oxygen content can be measured in the same manner as in (3) even after the sample is heated at 60 to 95° C. together with the container.

Regarding the unit “% O₂” generally known as a unit indicating the dissolved oxygen content, in a state in which oxygen is dissolved to saturation in a liquid in air at atmospheric pressure, the dissolved oxygen content is 20.9% O₂, which is the same as the oxygen partial pressure in air, regardless of the type of liquid. For example, the dissolved oxygen saturation concentrations (indicated by ppm) of pure water at 25° C. and cooking oil at 40° C. in air at atmospheric pressure are respectively about 8.1 ppm and about 37.9 ppm. On the other hand, when indicating the dissolved oxygen content using the unit “% O₂”, pure water and cooking oil have a dissolved oxygen content of 20.9% O₂.

The unit “% O₂” is used in the invention because the dissolved oxygen content in the potato product is accurately indicated by the unit “% O₂”, and the unit “% O₂” is universal.

Specifically, the detection section (sensor) of the oxygen sensor generally has a structure in which a measurement signal is generated corresponding to the oxygen partial pressure. Since the measurement signal and the dissolved oxygen content indicated by the unit “% O₂” have a proportional relationship, the measurement results indicated by the unit “% O₂” can be directly obtained. Therefore, when indicating the dissolved oxygen content by ppm or the like, it is necessary to convert the data indicated by the unit “% O₂”, which is obtained from the measurement results using the oxygen sensor, into ppm or the like using a conversion table corresponding to the individual sample solution and the measurement temperature. Since a formal or universal conversion table does not exist for the potato product, it is difficult to indicate the accurate measurement results by ppm or the like which requires conversion.

The heating step (b) according to this embodiment is preferably carried out in deoxygenated water with a dissolved oxygen content of 6% O₂ or less. Use of deoxygenated water with a low dissolved oxygen content prevents entrance of oxygen from the outside of the container in the heating step, whereby the effects of oxidation on the potatoes can be reduced. This more reliably produces the excellent flavor of the potato product and maintains the excellent flavor for a long time.

In the heating step (b) according to this embodiment, the dissolved oxygen content in the container before heating is usually higher than 5% O₂. However, oxygen is absorbed into the potatoes (particularly lipids contained in the potatoes) during heating, whereby the above-mentioned dissolved oxygen content is obtained during heating or at least immediately after heating.

In this embodiment, treatment water used for various types of treatment may be deoxygenated. As examples of the treatment water, freshwater used in the treatment performed before the enclosing step (a), such as freshwater used for the treatment liquid for preventing discoloration and breakage of the potatoes and freshwater used to blanch or boil the potatoes, freshwater used in the heating step (b), and the like can be given. The excellent flavor of the potato product can be more reliably produced and maintained for a long time by removing oxygen from the treatment water in advance to prepare deoxygenated water.

The treatment water may be deoxygenated using a known method. For example, a bubbling method in which an inert gas such as nitrogen, carbon dioxide, or argon is bubbled into freshwater in a freshwater storage tank or a pipe to replace dissolved oxygen with the inert gas, a membrane degassing method, or the like may be used.

In this embodiment, deoxygenation treatment may be performed in various steps in addition to deoxygenating the treatment water. For example, a method may be employed in which an inert gas is bubbled into the container filled with the potatoes.

Note that nitrogen is suitable as the inert gas because nitrogen abundantly exists in air, is relatively inexpensive, and does not affect the flavor and the quality of the potato product. A closed production line may also be employed so that oxygen in air is not mixed into the potato product during production.

According to this embodiment, the potato product can produce extremely excellent flavor, such as a flavor similar to that of roasted chestnuts or boiled chestnuts, by performing the heating step (b) employing specific dissolved oxygen content conditions. The excellent flavor of the potato product can be obtained even if another heating step such as blanching is performed in air before the heating step (b). Moreover, the flavor of the potato product can be more reliably produced in the heating step (b) and maintained for a long time by removing oxygen from the treatment water or performing a deoxygenation treatment in various steps.

The potato product according to this embodiment has a dissolved oxygen content of preferably 5% O₂ or less, and more preferably 3% O₂ or less after being stored at 10° C. or less for 30 days after production. If the dissolved oxygen content in the potato product is within this range, the excellent flavor produced in the heating step (b) can be advantageously maintained until the potato product is eaten.

The component analysis conducted by the inventors has confirmed that the potato product according to this embodiment includes a large amount of flavor component which produces excellent flavor. Specifically, when analyzing the volatile components of the potato product by solid-phase microextraction-gas chromatography-mass spectrometry in which the volatile components are extracted at 80° C. for 30 minutes, the ratio (flavor component/oxidative degradation odor component) of the peak area (quantitative ion: m/z 104) of methional (flavor component) to the sum of the peak areas (quantitative ion: m/z 81) of 2,4-nonadienal and 2,4-decadienal (oxidative degradation odor components) is preferably 3.8 or more, and more preferably 5.0 or more, as is clearly from the examples described later.

When analyzing the volatile components of the potato product by solid-phase microextraction-gas chromatography-mass spectrometry in which the volatile components are extracted at 95° C. for 10 minutes after preheating the potato product at 95° C. for 20 minutes, and analyzing the volatile components (oxidative degradation odor components) of the potato product by solid-phase microextraction-gas chromatography-mass spectrometry in which the volatile components are extracted at 95° C. for 10 minutes after preheating the potato product at 95° C. for 20 minutes, the ratio (flavor component/oxidative degradation odor component) of the peak area (quantitative ion: m/z 104) of methional (flavor component) to the sum of the peak areas (quantitative ion: m/z 81) of 2,4-nonadienal and 2,4-decadienal (oxidative degradation odor components) is preferably 5.3 or more, and more preferably 11.0 or more, as is clear from the examples described later.

It was confirmed that the above ratio (flavor component/oxidative degradation odor component) is significantly higher than that when subjecting the potato product to retort sterilization, and is also higher than that of a general steamed potato product (e.g. homemade potato dish).

### 2. Second Embodiment

This embodiment relates to a potato product obtained using a semifinished product prepared by processing potatoes instead of directly processing potatoes. As examples of such a potato product, a potato salad, mashed potatoes, a Japanese hotchpotch (oden), a meat and potato stew, and the like can be given.

A process for producing a potato product according to this embodiment includes hermetically enclosing a semifinished product containing potatoes in a container, and heating the semifinished product at 60 to 95° C. The semifinished product is heated under conditions where the dissolved oxygen content in the container becomes 5% O₂ or less at least when heating is completed.

In this embodiment, a container having an average oxygen permeability of 5 cc/m²·day·atm or less may be used as the container. In this embodiment, the semifinished product may be heated in deoxygenated water with a dissolved oxygen content of 6% O₂ or less. The above embodiments relating to the container and the heating step may be employed in combination.

Each step is described below in detail.

In a step (A) of hermetically enclosing the semifinished product containing potatoes in the container (hereinafter called “enclosing step (A)”), a semifinished product containing potatoes is produced and enclosed in a bag-shaped container, and the container is sealed while removing air from the container using a vacuum sealing method or the like.

The semifinished product is produced using a known method depending on the type of potato product.

An example of the method of producing the semifinished product is described below taking the case where the potato product is a potato salad.

The potatoes are subjected to necessary pretreatment, cut into an appropriate size, and heated using a steamer. After cooling the steamed potatoes, other raw materials such as vegetables (e.g. carrots and onions) cut into an appropriate size, an oil-in-water emulsified food (e.g. mayonnaise), seasoning (e.g. salt), spice, and optional freshwater are added to the potatoes. The raw materials are mixed using a mixer.

When the potato product is mashed potatoes, the semifinished product is obtained as follows, for example. Specifically, the potatoes are subjected to necessary pretreatment, cut into an appropriate size, and steamed. After the addition of raw materials such as the potatoes, milk, butter, and salt to a mixer, the raw materials are stirred until a homogenous mixture is obtained.

The potatoes used as the raw material for the semifinished product may be pretreated in the same manner as in the first embodiment.

It is preferable that the container used in the enclosing step (A) according to this embodiment be a bag-shaped container having a low oxygen permeability in the same manner as described in the first embodiment. The oxygen permeability, the material, and the like of the container are the same as described in the first embodiment.

The excellent flavor of the potatoes produced in a heating step (B) described later is stably maintained for a long time by using a container formed of a material having a low oxygen permeability. In particular, the excellent flavor produced immediately after production can be maintained for a long time of 30 days or more by using a container having an average oxygen permeability of 5 cc/m²·day·atm or less, as is clear from the examples described later.

In the step (B) of heating the semifinished product containing the potatoes which is hermetically enclosed in the container (hereinafter called “heating step (B)”), the semifinished product is heated at 60 to 95° C., preferably 65 to 95° C., and more preferably 70 to 95° C. If the temperature of the heating step (B) is less than 60° C., the storage properties of the potato product deteriorate due to insufficient thermal sterilization. Moreover, the excellent flavor of the potatoes may not be produced. If the temperature of the heating step (B) exceeds 95° C., as employed in retort sterilization (usually 100° C.), it is also difficult to produce the excellent flavor of the potatoes. The heating time in the heating step (B) is not particularly limited. The heating time may be determined so that the semifinished product can be sterilized (e.g. 30 to 90 minutes). It is preferable to cool the container-packed potato product after the heating step (B) from the viewpoint of improving the flavor of the potato product.

The heating step (B) is carried out under conditions where the dissolved oxygen content in the container becomes 5% O₂ or less, and preferably 3% O₂ or less at least when heating is completed. The term “dissolved oxygen content” is the same as described in the first embodiment.

The heating step (B) is preferably carried out in deoxygenated water with a dissolved oxygen content of 6% O₂ or less. Use of deoxygenated water with a small dissolved oxygen content prevents entrance of oxygen from the outside of the container in the heating step, whereby the effects of oxidation on the potato semifinished product can be reduced. This more reliably produces the excellent flavor of the potato product and maintains the excellent flavor for a long time.

In the heating step (B) according to this embodiment, the dissolved oxygen content in the container before heating is usually higher than 5% O₂. However, oxygen is consumed for oxidation of lipids in the oil-in-water emulsified food (e.g. mayonnaise) and the potatoes contained in the semifinished product and the like during heating, whereby the above-mentioned dissolved oxygen content is obtained during heating or at least immediately after heating.

In the process for producing a potato product according to this embodiment, at least some of the materials for the semifinished product may be deoxygenated. The materials to be deoxygenated are mainly the oil-in-water emulsified food and freshwater.

In this embodiment, treatment water used for various types of treatment may be deoxygenated. As examples of the treatment water, freshwater used in the treatment performed before the enclosing step (A), such as freshwater used for the treatment liquid for preventing discoloration and breakage of the potatoes and freshwater used to steam or boil the potatoes, freshwater used in the heating step (B), and the like can be given. The excellent flavor of the potato product can be more reliably produced and maintained for a long time by removing oxygen from the treatment water in advance to prepare deoxygenated water. The treatment water may be deoxygenated in the same manner as in the first embodiment.

In this embodiment, deoxygenation treatment may be performed in various steps in addition to deoxygenating the treatment water. For example, a method in which an inert gas is bubbled into a closed mixer under pressure in the stirring step when producing the semifinished product, a method in which an inert gas is bubbled into the container filled with the semifinished product, or the like may be used. Nitrogen is suitable as the inert gas for the same reasons as described in the first embodiment. A closed production line may be employed so that oxygen in air is not mixed into the potato product during production.

According to this embodiment, the potato product can produce extremely excellent flavor, such as a flavor similar to that of roasted chestnuts or boiled chestnuts, by performing the heating step (B) employing specific dissolved oxygen content conditions. The excellent flavor of the potato product can be produced in the heating step (B) even if another heating step or stirring step is performed in air before the heating step (B). Moreover, the flavor of the potato product can be more reliably produced in the heating step (B) by removing oxygen from the treatment water or performing deoxygenation treatment in various steps, as described above.

A potato product according to the invention is obtained by the process for producing a potato product according to the invention. The potato product has a dissolved oxygen content of preferably 5% O₂ or less, and more preferably 3% O₂ or less after being stored at 10° C. or less for 30 days after production. If the dissolved oxygen content in the potato product is within this range, the excellent flavor produced in the heating step (B) can be advantageously maintained until the potato product is eaten.

### 3. Examples

Sealed-container-packed potato products according to the examples of the invention and a process for producing the same are described below. Note that the invention is not limited to the following examples. Examples 1 and 2 and Examples 7 and 8 relate to boiled potatoes, Examples 3 to 5 relate to a potato salad, and Example 6 relates to mashed potatoes.

### 3.1. Example 1

After peeling the potatoes using a steam peeler, the potatoes were immersed in an immersion liquid (0.05% aqueous solution of sodium L-ascorbate) to prevent discoloration of the potatoes. Then, sprouts and discolored portions were removed from the potatoes. The potatoes were cut into four portions (20 to 40 g). The cut potatoes were immersed in an immersion liquid for 30 to 120 minutes. The immersion liquid used contained 10 g of sodium L-ascorbate, 9 g of fermentation lactic acid, 20 g of sodium chloride, and 20 kg of freshwater. The potatoes were then exposed to water in order to remove the immersion liquid. After sufficiently draining the potatoes, a pouch having a low oxygen permeability was charged with 250 g of the potatoes and vacuum-sealed. A pouch (dimensions: 20 cm×13 cm, average oxygen permeability: about 0.3 cc/m²·day·atm) was used which was formed by bag-making a stacked film formed of polyacrylic acid resin-coated polyethylene terephthalate/polyamide/polyethylene (“Besela” manufactured by Kureha Corporation).

The potatoes hermetically enclosed in the pouch were heated (sterilized) in hot water at 90° C. for 45 minutes. The potatoes were then cooled in water at 7° C. for 60 minutes to produce boiled potatoes.

### 3.2. Example 2

After peeling the potatoes using a steam peeler, the potatoes were immersed in an immersion liquid (0.05% aqueous solution of sodium L-ascorbate) to prevent discoloration of the potatoes. After removing sprouts and discolored portions from the potatoes, the potatoes were cut into four portions using a cutter, and defective cut products were removed. After sorting, the potatoes were immersed in a 0.04% sodium L-sorbate aqueous solution and stored overnight in a refrigerator.

The potatoes were then blanched at 87° C. for 10 minutes using an aqueous solution containing 1% of sodium chloride. A pouch (“Besela” manufactured by Kureha Corporation) similar to that used in Example 1 was charged with 250 g of the potatoes and vacuum-sealed.

The potatoes enclosed in the pouch were heated (sterilized) in hot water at 90° C. for 45 minutes. The potatoes were then cooled in water at 7° C. for 60 minutes to produce boiled potatoes.

### Test Example 1

### 1. Test Method

After storing the boiled potato samples obtained in Examples 1 and 2 in a refrigerator at 10° C. for 30 days (chilled storage), the dissolved oxygen content was measured.

### 2. Evaluation Method

The dissolved oxygen content of each sample was measured using an oxygen sensor “OxySense101” (manufactured by OxySense, Inc.). In the measurement of the dissolved oxygen content, an oxygen detection fluorescent dye film “OxyDot” was attached to specific portions of the inner surface of the pouch (almost the center of the pouch and a portion near the heat sealing portion in this example), and the dissolved oxygen content was determined by averaging the values measured at these two portions. The dissolved oxygen content was measured at room temperature.

As shown in Table 1, the dissolved oxygen content was measured before and after heating and after chilled storage. The flavor of the sample was evaluated by eating the sample. The flavor was evaluated immediately after production and after chilled storage according to a 10-grade method. The overall evaluation was carried out according to a 10-grade method. The measurement results and the evaluation results are shown in Table 1.

TABLE 1

| | | | Dissolved | | | |
|---|---|---|---|---|---|---|
| | Dissolved | Dissolved | oxygen content | Flavor | Flavor after 30 | |
| | oxygen content | oxygen content | after 30 days of | immediately | days of chilled | Overall |
| | before heating¹⁾ | after heating²⁾ | chilled storage | after production | storage | evaluation |
| Example 1 | 18 | 2 | 2 | 10 | 9 | 9 |
| Example 2 | 17 | 2 | 3 | 9 | 8 | 8 |

Values in table: dissolved oxygen content (% O₂)
¹⁾Measured immediately after vacuum-sealing the pouch filled with the potatoes.
²⁾Measured immediately after heating and cooling the potatoes.

### 3.3. Example 3

After peeling the potatoes, sprouts were removed. After cutting the potatoes into an appropriate size, the potatoes were heated at 95 to 100° C. for about 60 minutes using a steamer and cooled to 30 to 50° C. 62 kg of the resulting potatoes, 2 kg of carrots, 5 kg of onions, 20 kg of deoxygenated mayonnaise (manufactured by Q.P. Corporation), 0.3 kg of sodium chloride, 0.3 kg of sugar, 0.3 kg of sodium glutamate, 0.1 kg of spice, and 10 kg of freshwater were homogenously mixed with stirring using a mixer to produce a potato salad semifinished product. The deoxygenated mayonnaise used was prepared by reducing the dissolved oxygen content to about 3% O₂ by bubbling nitrogen gas into the raw material salad oil. When mixing the raw materials with stirring, oxygen was replaced with nitrogen while repeatedly removing gasses and injecting nitrogen in the mixer.

A pouch (“Besela” manufactured by Kureha Corporation) similar to that used in Example 1 was charged with 250 g of the semifinished product and vacuum-sealed. The dissolved oxygen content was 5% O₂. The semifinished product was heated (sterilized) in deoxygenated water at 70° C. for 60 minutes, and cooled in deoxygenated water at 5° C. for 60 minutes to produce a potato salad.

The deoxygenated water used was prepared using a membrane degassing module “SEPAREL KDO-01S2” (manufactured by Dainippon Ink and Chemicals, Inc.), and had a dissolved oxygen content of about 6% O₂.

### 3.4. Example 4

After peeling the potatoes, sprouts were removed. After cutting the potatoes into an appropriate size, the potatoes were heated at 95 to 100° C. for about 60 minutes using a steamer and cooled to 30 to 50° C. 62 kg of the resulting potatoes, 2 kg of carrots, 5 kg of onions, 20 kg of deoxygenated mayonnaise (manufactured by Q.P. Corporation), 0.3 kg of sodium chloride, 0.3 kg of sugar, 0.3 kg of sodium glutamate, 0.1 kg of spice, and 10 kg of freshwater were homogenously mixed with stirring using a mixer to produce a potato salad semifinished product. As the deoxygenated mayonnaise, deoxygenated mayonnaise was used which was prepared by reducing the dissolved oxygen content to about 3% O₂ by bubbling nitrogen gas into the raw material salad oil.

A pouch (“Besela” manufactured by Kureha Corporation) similar to that used in Example 1 was charged with 250 g of the resulting semifinished product and vacuum-sealed. The dissolved oxygen content was 15% O₂. The semifinished product was heated (sterilized) in hot water at 70° C. for 60 minutes, and cooled in water at 5° C. for 60 minutes to produce a potato salad.

### 3.5. Example 5

After peeling the potatoes, sprouts were removed. After cutting the potatoes into an appropriate size, the potatoes were heated at 95 to 100° C. for about 60 minutes using a steamer and cooled to 30 to 50° C. 62 kg of the resulting potatoes, 2 kg of carrots, 5 kg of onions, 20 kg of mayonnaise (Mayonnaise 205 manufactured by Q.P. Corporation), 0.3 kg of sodium chloride, 0.3 kg of sugar, 0.3 kg of sodium glutamate, 0.1 kg of spice, and 10 kg of freshwater were homogenously mixed with stirring using a mixer. A pouch (“Besela” manufactured by Kureha Corporation) similar to that used in Example 1 was charged with 250 g of the semifinished product and vacuum-sealed. The dissolved oxygen content was 18% O₂. The semifinished product was heated (sterilized) in hot water at 70° C. for 60 minutes, and cooled in water at 5° C. for 60 minutes to produce a potato salad.

### 3.6. Comparative Example 1

After peeling the potatoes, sprouts were removed. After cutting the potatoes into an appropriate size, the potatoes were heated at 95 to 100° C. for about 60 minutes using a steamer and cooled to 30 to 50° C. 62 kg of the resulting potatoes, 2 kg of carrots, 5 kg of onions, 20 kg of mayonnaise (Mayonnaise 205 manufactured by Q.P. Corporation), 0.3 kg of sodium chloride, 0.3 kg of sugar, 0.3 kg of sodium glutamate, 0.1 kg of spice, and 10 kg of freshwater were homogenously mixed with stirring using a mixer. A pouch (average oxygen permeability: about 8 cc/m²·day·atm) obtained by bag-making a stacked film formed of polyamide/polyethylene was charged with 250 g of the resulting semifinished product and vacuum-sealed. The dissolved oxygen content was 18% O₂. The semifinished product was heated (sterilized) in deoxygenated water at 70° C. for 60 minutes, and cooled in deoxygenated water at 5° C. for 60 minutes to produce a potato salad. The deoxygenated water used was prepared using a membrane degassing module “SEPAREL KDO-01S2” (manufactured by Dainippon Ink and Chemicals, Inc.) and had a dissolved oxygen content of about 6% O₂.

### 3.7. Comparative Example 2

After peeling the potatoes, sprouts were removed. After cutting the potatoes into an appropriate size, the potatoes were heated at 95 to 100° C. for about 60 minutes using a steamer and cooled to 30 to 50° C. 62 kg of the resulting potatoes, 2 kg of carrots, 5 kg of onions, 20 kg of mayonnaise (Mayonnaise 205 manufactured by Q.P. Corporation), 0.3 kg of sodium chloride, 0.3 kg of sugar, 0.3 kg of sodium glutamate, 0.1 kg of spice, and 10 kg of freshwater were homogenously mixed using a mixer. A pouch similar to that used in Comparative Example 1 was charged with 250 g of the semifinished product and vacuum-sealed. The dissolved oxygen content was 18% O₂. The semifinished product was heated (sterilized) in hot water at 70° C. for 60 minutes, and cooled in water at 5° C. for 60 minutes to produce a potato salad.

### Test Example 2

### 1. Test Method

After storing the potato salad samples obtained in Examples 3 to 6 and Comparative Example 1 in a refrigerator at 10° C. for 30 days (chilled storage), the dissolved oxygen content was measured.

### 2. Evaluation Method

The dissolved oxygen content of each sample was measured in the same manner as in Test Example 1 using an oxygen sensor “OxySensell” (manufactured by OxySense, Inc.). As shown in Table 2, the dissolved oxygen content was measured before and after heating and after chilled storage. The flavor of the sample was evaluated by eating the sample. The flavor was evaluated immediately after production and after chilled storage according to a 10-grade method. The overall evaluation was carried out according to a 10-grade method. The measurement results and the evaluation results are shown in Table 2.

TABLE 2

| | | | Dissolved | | | |
|---|---|---|---|---|---|---|
| | Dissolved | Dissolved | oxygen content | Flavor | Flavor after 30 | |
| | oxygen content | oxygen content | after 30 days of | immediately | days of chilled | Overall |
| | before heating¹⁾ | after heating²⁾ | chilled storage | after production | storage | evaluation |
| Example 3 | 5 | 0 | 0 | 9 | 9 | 9 |
| Example 4 | 15 | 2 | 2 | 8 | 8 | 9 |
| Example 5 | 18 | 2 | 3 | 7 | 7 | 7 |
| Comparative | 18 | 2 | 8 | 6 | 2 | 5 |
| Example 1 | | | | | | |
| Comparative | 18 | 2 | 10 | 3 | 2 | 3 |
| Example 2 | | | | | | |

Values in table: dissolved oxygen content (% O₂)
¹⁾Measured immediately after vacuum-sealing the pouch filled with the salad semifinished product.
²⁾Measured immediately after heating and cooling the salad semifinished product.

As is clear from Table 2, the pouch having a low oxygen permeability and the deoxygenated mayonnaise were used in Examples 3 and 4. In Example 3, the product was heated in deoxygenated water, and the dissolved oxygen content before heating was 15% O₂ or less. In Examples 3 and 4, the dissolved oxygen content was not increased during chilled storage. This confirmed that the potato salads obtained in Examples 3 and 4 exhibited an excellent flavor immediately after heating and during chilled storage.

In Example 5, the pouch having a low oxygen permeability was used. The dissolved oxygen content before heating was 18% O₂ or less and was increased to only a small extent during chilled storage. This confirmed that the potato salad obtained in Example 5 exhibited excellent flavor immediately after heating and during chilled storage.

In Comparative Example 1, the pouch was used having an oxygen permeability higher than that of Examples 3 to 5, and the product was heated in deoxygenated water. The dissolved oxygen content before heating was 18% O₂ or less, and was increased to some extent during chilled storage. This confirmed that the potato salad obtained in Comparative Example 1 exhibited inferior flavor to some extent after chilled storage in comparison with the flavor immediately after heating.

In Examples 3 to 5 and Comparative Example 1, the dissolved oxygen content after heating was 2% O₂ or less. In Examples 3 to 5, the dissolved oxygen content after 30 days of chilled storage was 3% O₂ or less. In Comparative Example 1, the dissolved oxygen content after 30 days of chilled storage was 8% O₂. In Comparative Example 2, the dissolved oxygen content after heating was 2% O₂, and was 10% O₂ after 30 days of chilled storage.

### 3.8. Example 6

After peeling the potatoes, sprouts were removed. After cutting the potatoes into an appropriate size (about ⅛), the potatoes were heated at 95 to 100° C. for about 60 minutes using a steamer. After the addition of 12 kg of the potatoes, 1.86 kg of milk, 0.5 kg of butter, 0.16 kg of sodium chloride, 0.02 kg of spice, and 0.16 kg of olive oil to a mixer, the materials were mixed with stirring until a homogenous mixture was obtained to produce a mashed potato semifinished product. A pouch (average oxygen permeability: about 5 cc/m²·day·atm) obtained by bag-making a stacked film formed of polyamide/polyethylene was charged with 250 g of the resulting semifinished product and vacuum-sealed. The potatoes enclosed in the pouch were heated (sterilized) in hot water at 90° C. for 40 minutes. The semifinished product was then cooled in water at 5° C. for 60 minutes to produce mashed potatoes.

### Test Example 3

### 1. Test Method

After storing the mashed potato sample obtained in Example 6 in a refrigerator at 10° C. for 30 days (chilled storage), the dissolved oxygen content was measured.

### 2. Evaluation Method

The dissolved oxygen content of each sample was measured in the same manner as in Test Example 1 using an oxygen sensor “OxySense101” (manufactured by OxySense, Inc.). As shown in Table 3, the dissolved oxygen content was measured before and after heating and after chilled storage. The flavor of the sample was evaluated by eating the sample. The flavor was evaluated immediately after production and after chilled storage according to a 10-grade method. The overall evaluation was carried out according to a 10-grade method. The measurement results and the evaluation results are shown in Table 3.

TABLE 3

| | | | Dissolved | | | |
|---|---|---|---|---|---|---|
| | Dissolved | Dissolved | oxygen content | Flavor | Flavor after 30 | |
| | oxygen content | oxygen content | after 30 days of | immediately | days of chilled | Overall |
| | before heating¹⁾ | after heating²⁾ | chilled storage | after production | storage | evaluation |
| Example 6 | 18 | 3 | 5 | 8 | 6 | 7 |

Values in table: dissolved oxygen content (% O₂)
¹⁾Measured immediately after vacuum-sealing the pouch filled with the mashed potato semifinished product.
²⁾Measured immediately after heating and cooling the mashed potato semifinished product.

The above results confirmed that the potato products according to the examples of the invention can produce an excellent flavor by heating and maintain the excellent flavor for a long time.

### 3.9. Example 7

A pouch (“Besela” manufactured by Kureha Corporation) similar to that used in Example 1 was charged with 150 g of “Sayaka” potatoes which had been peeled and cut into four portions. The pouch was then vacuum-sealed. The hermetically enclosed potatoes were heated in hot water at 95° C. for 50 minutes, and cooled in water at 5° C. for 60 minutes to produce boiled potatoes.

The volatile components of the resulting boiled potatoes were analyzed by solid-phase microextraction-gas chromatography-mass spectrometry (SPME-GC-MS). A little more than 3 g of the boiled potatoes were collected in a vial (volume: 10 ml). The boiled potatoes were homogeneously crushed for one minute using a plastic rod to obtain a mashed potato sample. After adjusting the content of the sample to 3 g, the vial was sealed using a septum (PTFE/silicone) cap. A solid-phase microextraction fiber was exposed in the vial to extract the volatile components of the sample. The volatile components were then immediately subjected to gas chromatographic analysis.

The conditions for solid-phase microextraction and gas chromatographic analysis were as follows.

### <Solid-Phase Microextraction (SPME) Conditions>

SPME fiber: StableFlex 50/30 micrometers, DVB/Carboxen/PDMS (Supelco, Inc., Bellefonte, Pa.)
Extraction: The sample was heated at 80° C. for 30 minutes, and the volatile components in the headspace were extracted.

### <Gas Chromatography Conditions>

Column: Supelcowax-10 (Supelco Inc., Bellefonte, Pa.; phase polyethylene glycol, 30 m, i.d. 0.25 mm, film 0.25 micrometers)
GC temperature conditions: 35° C. (5 min) [symbol] 5° C./min (temperature rise rate) [symbol] 120° C. [symbol] 15° C./min (temperature rise rate) [symbol] 220° C. (5 min)
Carrier: He, 1.0 ml/min, constant flow rate mode
Injection: splitless (1.5 min), purge 20 ml/min
Inlet: 250° C., 47 kPa (start)
GC oven: Hewlett Packard HP-6890

### <Mass Spectrometry Conditions>

Mass detector: JMS-AMSUN 200 manufactured by JEOL Ltd.
Mass scan range: m/z 29.0 to 290.0
Ion source: El (70 eV)
Electron multiplier voltage: 600 V

Identification was judged from the similarity of the mass spectrum of each peak. The results are shown in Table 4. Table 4 shows the sum of the peak areas (quantitative ion: m/z 81) of 2,4-nonadienal and 2,4-decadienal (main oxidative degradation odor components), the peak area (quantitative ion: m/z 104) of methional (main flavor component), and the ratio (M)/{(N)+(D)} of the peak area of methional to the sum of the peak areas of 2,4-nonadienal and 2,4-decadienal.

### 3.10. Comparative Example 3

The volatile components were analyzed in the same manner as in Example 7 except for using a pouch similar to that used in Comparative Example 1 instead of the pouch used in Example 7. The results are shown in Table 4.

### 3.11. Comparative Example 4

150 g of “Danshaku” potatoes were peeled, cut into four portions, and heated at 97° C. for 50 minutes using a steamer. After cooling the potatoes to 15° C. using a vacuum cooler, the volatile components were analyzed in the same manner as in Example 7. The results are shown in Table 4.

TABLE 4

| | | Example 7 | | Comparative Example 3 | | Comparative Example 4 | |
|---|---|---|---|---|---|---|---|
| | | 100% | Peak area | 100% | Peak area | 100% | Peak area |
| (M) | Methional | 174 | 12507199 | 100 | 7180579 | 132 | 9511344 |
| (N) | 2,4-Nonadienal | 25 | 1672402 | 100 | 6561171 | 11 | 714953 |
| (D) | 2,4-Decadienal | 4 | 618454 | 100 | 16443370 | 11 | 1817111 |

| | | | |
|---|---|---|---|
| (N) + (D) | 2290856 | 23004541 | 2532064 |
| (M)/{(N) + (D)} | 5.46 | 0.31 | 3.76 |

The results shown in Table 4 confirmed that the sample of Example 7 contained a significantly large amount of flavor component and significantly small amounts of oxidative degradation odor components in comparison with the sample of Comparative Example 3. It was also confirmed that the sample of Example 7 contained a large amount of flavor component and a small amount of 2,4-decadienal as the oxidative degradation odor component in comparison with the sample (steamed sample) of Comparative Example 4 which was merely steamed without being enclosed in a container. This indicates that the sample of Example 7 contained an excellent flavor component in comparison with the steamed sample. As described above, it was confirmed that an excellent flavor was produced in the example according to the invention not only by the sensory test, but also by the odor component analysis.

### 3.12. Comparative Example 5

Boiled potatoes were produced in the same manner as in Example 1 except for heating the potatoes at 118° C. for 30 minutes using a retort sterilizer (retort sterilization) instead of heating the potatoes in hot water.

The resulting boiled potatoes were subjected to dissolved oxygen content measurement and flavor evaluation in the same manner as in Test Example 1. Note that dissolved oxygen content measurement and flavor evaluation after chilled storage were not conducted. The results are shown in Table 5.

TABLE 5

| | Dissolved oxygen | Dissolved oxygen | Flavor immediately after | |
|---|---|---|---|---|
| | content before heating¹⁾ | content after heating²⁾ | production | Overall evaluation |
| Comparative | 18 | 0 | 2 | 2 |
| Example 5 | | | | |

Values in table: dissolved oxygen content (% O₂)
¹⁾Measured immediately after vacuum-sealing the pouch filled with the potatoes.
²⁾Measured immediately after heating and cooling the potatoes.

As is clear from Table 5, it was found that the flavor of the potatoes considerably deteriorates, even if a pouch having a low oxygen permeability is used, when the potatoes are heated at a temperature exceeding 95° C.

### 3.13. Example 8

A pouch (dimensions: 20 cm×13 cm, average oxygen permeability: about 0.3 cc/m²·day·atm) formed by bag-making a stacked film formed of polyacrylic acid resin-coated polyethylene terephthalate/polyamide/polyethylene (manufactured by Dai Nippon Printing Co., Ltd.) was charged with about 150 g of “Sayaka” potatoes which had been peeled and cut into two portions. The pouch was then vacuum-sealed. The hermetically enclosed potatoes were heated in hot water at 90° C. for 60 minutes, and cooled in water at 5° C. for 60 minutes to produce boiled potatoes.

The volatile components of the resulting boiled potatoes were analyzed by solid-phase microextraction-gas chromatography-mass spectrometry (SPME-GC-MS). The boiled potatoes hermetically enclosed in the pouch were crushed by hand to obtain a mashed potato sample. After collecting 3 g of the sample in a vial (volume: 10 mL, for headspace), the vial was sealed using a septum (PTFE/silicone) cap. The volatile components of the sample were extracted using a volatile component extractor. After preheating the vial containing the sample to generate gases containing the volatile components in the headspace, a solid-phase microextraction fiber was exposed in the vial, and the volatile components of the sample were extracted with heating. The volatile components were then immediately subjected to gas chromatography analysis.

The conditions for solid-phase microextraction and gas chromatographic analysis were as follows.

### <Solid-Phase Microextraction (SPME) Conditions>

SPME fiber: StableFlex 50/30 micrometers, DVB/Carboxen/PDMS (Supelco, Inc., Bellefonte, Pa.)
Volatile component extractor: Combi PAL (CTC Analitics)
Preheating: 95° C. for 20 minutes
Stirring speed: 500 rpm (agitator on 5 sec; off 2 sec)
Heating during volatile component extraction: The sample was heated at 95° C. for 10 minutes, and the volatile components in the headspace were extracted.
Desorption time: 5 minutes

### <Gas Chromatography Conditions>

GC oven: Agilent 6890N (Agilent Technologies)
Column: SOLGEL-WAX; 30 m, 0.25 mm i.d., 0.25 micrometers (SGE)
GC temperature conditions: 35° C. (5 min) [symbol] 5° C./min (temperature rise rate) [symbol] 120° C. [symbol] 15° C./min (temperature rise rate) [symbol] 220° C. (6 min)
Carrier: He, 1.0 ml/min, constant flow rate mode
Injection: pulsed splitless, splitless 1.5 min [symbol] purge 50 mL/min, pulse 100 kPa (1.6 min) [symbol] 47 kPa (start)
Inlet temperature: 250° C.

### <Mass Spectrometry Conditions>

### Workstation: MSD ChemStation Build 75 (Agilent Technologies)

Mass spectrometer: Agilent 5973N (Agilent Technologies)
Mass scan range: m/z 29.0 to 290.0
Ion source: El (70 eV)

Identification was judged from the similarity of the mass spectrum of each peak. The results are shown in Table 6. Table 6 shows the sum of the peak areas (quantitative ion: m/z 81) of 2,4-nonadienal and 2,4-decadienal (main oxidative degradation odor components), the peak area (quantitative ion: m/z 104) of methional (main flavor component), and the ratio (M)/{(N)+(D)} of the peak area of methional to the sum of the peak areas of 2,4-nonadienal and 2,4-decadienal.

### 3.14. Comparative Example 6

The volatile components were analyzed in the same manner as in Example 8 except for using a pouch similar to that used in Comparative Example 1 instead of the pouch used in Example 8. The results are shown in Table 6.

### 3.15. Comparative Example 7

About 150 g of “Sayaka” potatoes, which had been peeled and cut into two portions, were heated at 97 to 100° C. for 50 minutes using a steamer, and cooled to 15° C. using a vacuum cooler. A pouch similar to that used in Example 8 was charged with the resulting potatoes and vacuum-sealed. The volatile components were analyzed in the same manner as in Example 8. The results are shown in Table 6.

TABLE 6

| | | Example 8 | | Comparative Example 6 | | Comparative Example 7 | |
|---|---|---|---|---|---|---|---|
| | | 100% | Peak area | 100% | Peak area | 100% | Peak area |
| (M) | Methional | 96 | 846 | 100 | 877 | 71 | 623 |
| (N) | 2,4-Nonadienal | 34 | 18 | 100 | 55 | 114 | 62 |
| (D) | 2,4-Decadienal | 50 | 55 | 100 | 111 | 126 | 140 |

| | | | |
|---|---|---|---|
| (N) + (D) | 73 | 166 | 203 |
| (M)/{(N) + (D)} | 11.51 | 5.29 | 3.07 |

The results shown in Table 6 confirmed that the sample of Example 8 contained significantly small amounts of oxidative degradation odor components in comparison with the sample of Comparative Example 6. It was also confirmed that the sample of Example 8 contained a significantly large amount of flavor component and significantly small amounts of oxidative degradation odor components in comparison with the sample (steamed sample) of Comparative Example 7 which was merely steamed without being enclosed in a container. As described above, it was confirmed that an extremely excellent flavor was obtained in the example according to the invention.

1. A process for producing a potato product comprising:
hermetically enclosing potatoes in a container having an average oxygen permeability of 5 cc/m²·day·atm or less; and
heating the potatoes at 60 to 95° C., the potatoes being heated under conditions where dissolved oxygen content in the container becomes 5% O₂ or less at least when heating is completed.

2. The process for producing a potato product according to claim 1, wherein the potatoes are heated in deoxygenated water with a dissolved oxygen content of 6% O₂ or less.

3. The process for producing a potato product according to claim 1, further comprising heating the potatoes before hermetically enclosing the potatoes.

4. A process for producing a potato product comprising:
hermetically enclosing a semifinished product containing potatoes in a container having an average oxygen permeability of 5 cc/m²·day·atm or less; and
heating the semifinished product at 60 to 95° C., the semifinished product being heated under conditions where dissolved oxygen content in the container becomes 5% O₂ or less at least when heating is completed.

5. The process for producing a potato product according to claim 4, wherein the semifinished product is heated in deoxygenated water with a dissolved oxygen content of 6% O₂ or less.

6. The process for producing a potato product according to claim 4, wherein at least the potatoes contained in the semifinished product have been heated.

7. The process for producing a potato product according to claim 4, wherein at least some of materials contained in the semifinished product have been deoxygenated.

8. The process for producing a potato product according to claim 7, wherein the deoxygenated material is at least one of an oil-in-water emulsified food and freshwater.

9. A potato product obtained by the process according to claim 1 and having a dissolved oxygen content of 5% O₂ or less after being stored at 10° C. or less for 30 days after production.

10. A potato product obtained by the process according to claim 4 and having a dissolved oxygen content of 5% O₂ or less after being stored at 10° C. or less for 30 days after production.

11. A potato product having, when analyzing volatile components of the potato product by solid-phase microextraction-gas chromatography-mass spectrometry in which the volatile components are extracted at 80° C. for 30 minutes, a ratio (flavor component/oxidative degradation odor component) of a peak area (quantitative ion: m/z 104) of methional (flavor component) to sum of peak areas (quantitative ion: m/z 81) of 2,4-nonadienal and 2,4-decadienal (oxidative degradation odor components) of 3.8 or more.

12. A potato product having, when analyzing volatile components of the potato product by solid-phase microextraction-gas chromatography-mass spectrometry in which the volatile components are extracted at 95° C. for 10 minutes after preheating the potato product at 95° C. for 20 minutes, a ratio (flavor component/oxidative degradation odor component) of a peak area (quantitative ion: m/z 104) of methional (flavor component) to the sum of peak areas (quantitative ion: m/z 81) of 2,4-nonadienal and 2,4-decadienal (oxidative degradation odor components) of 5.3 or more.
